(19) United States
(12) Patent Application Publication
(10) Pub. No.: US 2016/0135930 A2
(43) Pub. Date: May 19, 2016

(54) DENTAL IMPLANT

(71) Applicants: Yohannes WOLDEGERGIS, Hanau (DE); Christian BAUER, Westerngrund (DE)

(72) Inventors: Yohannes WOLDEGERGIS, Hanau (DE); Christian BAUER, Westerngrund (DE)

(21) Appl. No.: 14/370,078

(22) Filed: Nov. 25, 2014

(51) Int. Cl. A61C 8/00; A61C 13/00; C08L 33/12

(52) U.S. Cl. CPC A61C 8/0016; C08L 33/12; A61C 13/00

(57) ABSTRACT

Dental implant comprising an implant adapter and a suprastructure, in which the implant adapter is coronally arched in at least some sections and the suprastructure is apically arched in at least some sections, the apical curvature of the suprastructure being convex and the coronal curvature of the implant adapter being concave, or the apical curvature of the suprastructure being concave and the coronal curvature of the implant adapter being convex, with the concave curvature.

This is a 371 of PCT/EP2012/005122, filed Dec. 12, 2012 (international filing date), claiming priority of German Application DE 10 2012 000 136.3.

The invention relates to a dental implant comprising an implant adapter and a suprastructure.

### BACKGROUND OF THE INVENTION

Dental implants and suprastructures are used in dental medicine to replace teeth that have been extracted or fell out. For this purpose, the dental implants are inserted into a jaw bone. A dental restoration is known from DE 103 58 680 A1, in which a stem is anchored in the jaw bone and a suprastructure can be affixed on the coronal region of the stem by means of adhesive bonding. It is customary to connect the stem and the suprastructure by means of a screw. Cements, for example, are used as adhesive bonds.

A coronal arrangement is understood to be an arrangement that is arranged in the direction of the crown of the tooth, for example in the direction of the mastication surface. In contrast, an apical arrangement is oriented towards the tip of the root of the tooth, i.e. in the direction of the jaw bone. Accordingly, coronal and apical arrangements are arranged in opposite directions with respect to each other. Referring to non-implanted dental implants, said specifications of direction refer to the directions that would result upon proper insertion of said dental implant into a jaw bone of a patient, and/or refer to the reproduced tooth.

Depending on the patient's status, for example the position of the jaw bone and the inaccuracies during the jaw surgery, the stem may not be oriented ideally for the dental restoration. An impression and an adhesive or cement can be used to still orient the suprastructure and/or the actual dental restoration, i.e. a bar, a crown, a bridge or an abutment, also including a prosthesis.

This is associated with a disadvantage in that a cement and/or adhesive must be applied to the patient. The respective parts often need to be re-worked in order to be adapted to the situation inside the oral space. Said subsequent orientation can result in non-optimal loading on the dental implant and ensuing pain, reduces durability, and other complications with the dental restoration. Moreover, extensive waiting times often need to be accepted during the re-working of the construct and/or the curing of the adhesive or cement.

Accordingly, it is the object of the invention to overcome the disadvantages of the prior art. In particular, a suprastructure is to be provided which can be inserted rapidly and easily and whose orientation can be adapted easily to the scenario existing in the oral space of a patient. The dental implant should not require cement or an adhesive, if at all possible. Moreover, it should be feasible to assemble the dental implant as easily as possible and without waiting times.

### SUMMARY OF THE INVENTION

The object is solved in that the implant adapter is coronally arched in at least some sections and in that the suprastructure is apically arched in at least some sections, whereby the apical curvature of the suprastructure is convex and the coronal curvature of the implant adapter is concave or the apical curvature of the suprastructure is concave and the coronal curvature of the implant adapter is convex, whereby the concave curvature is more pronounced (more intense) than the convex curvature such that, in the assembled dental implant, the suprastructure is connected to said implant adapter by a cutting edge.

### DETAILED DESCRIPTION

In the scope of the invention, a dental implant shall be understood not to mean the complete implant including prosthesis and stem. Accordingly, according to the present invention, a dental implant is already implemented through a suprastructure and an implant adapter. In addition, a dental implant according to the invention can just as well comprise a stem and/or a dental prosthesis. According to the invention, suprastructures shall be understood to be bars, bridges, abutments and other constructs for the implanted stem.

In this context, the invention can provide the convex curvature to be arched to be convex at a first radius R1 and the concave curvature to be arched concave at a second radius R2, whereby the first radius R1 is larger than the second radius R2.

A radial curvature is advantageous in that it is easier to be build-up technically and in that defined contact spots and/or a defined contact line arise as a cutting edge.

The curvature has to extend over at least a section of the afore-mentioned surfaces. Preferably, the edges of one of the curved surfaces form the cutting edge on the other curved surface. Radial curvatures can be formed, for example, by means of spherical surfaces and cylinder jackets. In this context, according to the invention, this is not meant to be complete spherical surfaces or cylinder jackets, but rather partial sections of spherical surfaces of cylinder jackets.

The invention can provide the radii R1 and R2 of the curved surfaces to be between 1 mm and 500 mm, preferably between 1.5 and 300 mm, particularly preferably between 5 and 100 mm.

Said radii result in the dental implants having sufficient curvature relative to the size of the dental implants and also sufficient curvature in order to provide a cutting edge.

Moreover, the invention can particularly preferably provide the convex curvature to be a convex spherical surface having a first radius R1 and the concave curvature to be a concave spherical surface having a second radius R2.

If spherical surfaces are employed, the suprastructure can compensate for an angle error not only in one direction, but in any direction. The spherical surfaces can be inclined with respect to each other in any direction such that the angle between the suprastructure and the implant adapter and/or the stem, on which the implant adapter is arranged, can be set freely in terms of its orientation. As before, the term, spherical surface, shall refer to a part of a spherical surface rather than a full spherical surface. Preferably, the spherical surface is smaller than a hemisphere of the same radius.

Regarding dental implants having radial curvature, the invention can provide the ratio of radii R1 to R2 to be less than 2:1, preferably to be in the range of 20:19 to 2:1, more preferably to be in the range of 10:9 to 4:3, particularly preferably the ratio of radii R1 to R2 to be 7:6.

Said ratios of the radii of curvature and/or radii of the spherical surfaces result in sufficient cutting edges while the design of the dental implant is compact and, most importantly, low in longitudinal direction.

The invention can particularly preferably provide the curved surfaces to comprise different diameters, such that, in the assembled dental implant, the external edge of the surface having the smaller diameter cuts as cutting edge into the surface having the larger diameter, whereby it is preferred for the external edge of the surface having the concave curvature to have a smaller diameter than the external edge of the convex surface, whereby the external edge of the surface having the concave curvature forms the cutting edge on the convex surface.

This ensures that the cutting edge can cut into the curved surface touching against it, preferably along the entire circumference. The cutting edge section being large leads to a stable and, most importantly, to a tighter connection. The tightness of the connection plays a major role for the dental implants due to the possible attachment of food residues and other sources of germs in non-tight spots and cavities.

Moreover, the invention can provide the implant adapter having the convex coronal surface to consist of a softer material than the suprastructure or the suprastructure having the convex apical surface to consist of a softer material than the implant adapter.

The hardness of the materials being different also leads to the cutting edge having a better cutting effect. This improves the stability and the tightness of the connection.

According to another embodiment, the invention can provide the implant adapter and/or the suprastructure to consist of a cobalt-chromium alloy, titanium, a titanium alloy and/or a ceramic material, in particular a zirconium oxide ceramic material.

Said materials are particularly well-suited for medical applications and afford high stability at low weight. Said ceramic materials are attractive due to their high hardness and their aesthetic appearance.

A particularly preferred embodiment of the invention can provide the dental implant to comprise a stem for implanting into the jaw bone, whereby the implant adapter can be placed on the stem or can be connected to the stem or is firmly connected to the stem or is designed to be the same part as the stem.

A stem of this type completes the dental implant for application in the patient. A firm or single-part connection of the stem to the implant adapter is particularly stable.

A particularly preferred embodiment of dental implants according to the invention results from providing the dental implant to comprise a screw for connecting the suprastructure to the implant adapter, whereby the screw comprises a thread for engaging an opposite thread, whereby the opposite thread preferably is arranged as internal thread in the stem, and the suprastructure and the implant adapter to comprise a feed-through for the screw, whereby, preferably, at least the diameter of the feed-through in the suprastructure is larger than the diameter of the screw in the region of the thread and smaller than the diameter of a screw head of the screw.

Due to the torque being transmittable to the suprastructure by linear force, the screws are particularly well-suited for producing a connection by means of the cutting edge. The diameter of the feed-through in the implant adapter can also be larger than the diameter of the screw in the region of the thread.

In this context, the invention can provide the suprastructure to comprise a convex coronal spherical surface having a radius R3 and the screw to possess, on the underside of the screw head, a concave spherical surface having the same radius R3 such that a surface-to-surface contact of the underside of the screw head to the coronal spherical surface of the suprastructure can be produced at different angles of the suprastructure with respect to the implant adapter.

As a result, the force can be transmitted by the screw to the suprastructure by means of the entire surface regardless of the inclination of the suprastructure with respect to the implant adapter.

Lastly, the invention can just as well provide the assembly of the dental implant, particularly by mounting the assemly of the dental implant, to include an angle between the implant adapter and the suprastructure and/or the stem and the suprastructure that can be adjusted from 0° to 5° preferably from 0° to 4°, more preferably from 0° to 3°, particularly preferably from 0° to 2°.

Said angles enable the design of the dental implant to be compact, whereby the angles are sufficient to compensate for most angle errors.

The invention is based on the surprising finding that, if a surface of a stem with an implant adapter and/or of an implant adapter for a stem has a curvature and the surface of the suprastructure has a different curvature, a suprastructure can be provided that is variable in terms of its orientation with respect to the implant adapter and/or stem, whereby the suprastructure and the implant adapter can be connected by means of a cutting edge. When the suprastructure gets connected to the stem by means of the implant adapter, for example in that a screw draws said parts together, an external edge of the more strongly curved surface is going to cut into the less strongly curved surface and form a cutting edge. As a matter of principle, it is feasible just as well, to have a sufficiently large recess in the less strongly curved surface and to also cut the edge of said recess of the less strongly curved surface into the more strongly curved surface, although this is less preferred according to the invention due to the projections and cavities that are thus generated. The formation of the cutting edge allows the suprastructure to be attached to the stem and/or the implant adapter at many different angles within a certain range.

The material getting cut should be softer than that of the cutting edge to allow the cutting edge to cut well into the arched surface in order to generate a firm and tight connection. The connection being tight ensures that no food residues or germs can become situated between the suprastructure and the implant adapter. This is another reason why an external cutting edge is preferred according to the invention.

The build-up according to the invention including spherical or arched surfaces allows angle errors to be compensated and to ensure a tight fit of the suprastructure to the actual implant (stem). The tightness and stability of the connection is based on the different curvatures and/or the different radii and the cutting effect. In this context, the suprastructure cuts into the surface of the implant adapter due to the torque of a screw (with ball seat) or of another connecting means.

The dental implant according to the invention provides a tension-free and angle error-compensating connection between a dental implant system having a stem anchored in an implant and a suprastructure (for example, a component of a prosthesis) without there being any need for cement materials.

Exemplary embodiments of the invention shall be illustrated in the following on the basis of two schematic figures, though without limiting the scope of the invention. In the figures:

### BRIEF DESCRIPTION OF THE DRAWINGS

FIG. 1: shows a schematic cross-sectional view of a dental implant according to the invention; and

FIG. 2: shows a magnified view of a detail of the schematic cross-sectional view of the dental implant according to the invention according to FIG. 1.

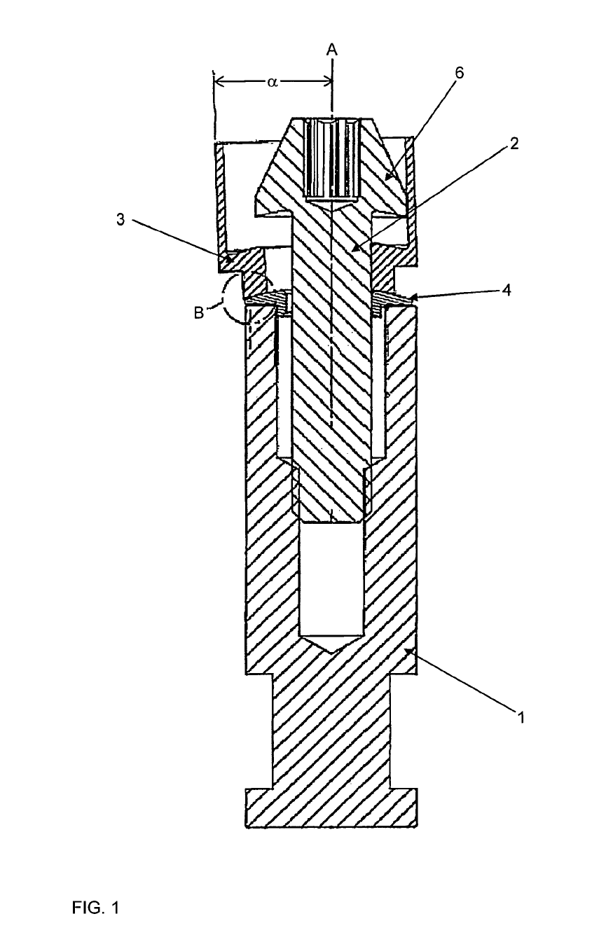

FIG. 1 shows a schematic cross-sectional view of a dental implant according to the invention. The dental implant comprises, apically (on the bottom in FIG. 1), a stem 1 that can be anchored in a jaw. The stem 1 comprises a recess on the coronal side for accommodation of a screw 2. For this purpose, the screw 2 has an external thread that engages an internal thread of the recess in the stem 1. Moreover, the screw 2 has a screw head 6 with a hexagon design or other engagement means for transmitting a torque to the screw 2. The screw axis A can be the symmetry axis of the stem 1.

The screw 2 serves to affix a suprastructure 3 on the stem 1. The actual dental restoration or another prosthetic appliance, such as, for example, a crown, a bar, a bridge, a denture or an abutment, can be assembled as suprastructure 3. An implant adapter 4 is arranged between the stem 1 and the suprastructure 3 in order to be able to fixedly adjust different angles between the suprastructure 3 and the stem 1. The implant adapter 4 can rest flat on the coronal surface of the stem 1 or can be connected firmly to the stem 1. It is feasible just as well to design the implant adapter 4 and the stem 1 to be a single component.

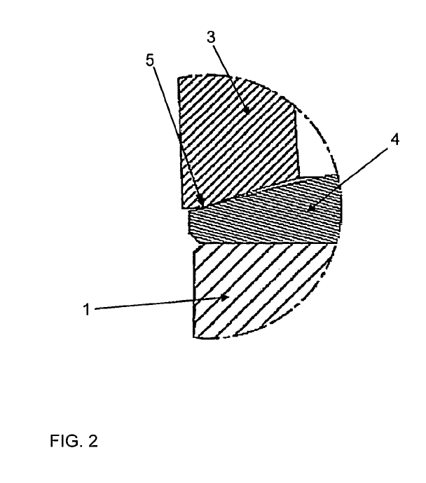

The coronal surface of the implant adapter 4 is curved in convex shape and forms a spherical surface having a radius R1 as support for the suprastructure 3. The suprastructure 3 has, on the apical side (lower side in FIG. 1), a concave spherical surface having a smaller external diameter than the convex coronal spherical surface of the implant adapter 4 and having a smaller radius of curvature R2 (radius of the spherical surface). For reasons of clarification, the contact region B between the suprastructure 3 and the implant adapter 4 shown framed by a circle in FIG. 1, is shown magnified in FIG. 2.

The suprastructure 3 can be affixed on the implant adapter 4 at different angles alpha (α) with respect to the screw axis A such as to be inclined in any direction. The maximal angle of inclination alpha (α) of the suprastructure 3 with respect to the implant adapter 4 is 2° in FIG. 1. Within this range of angles from 0° to 2°, the external edge of the apical concave surface of the suprastructure 3 rests with its full circumference on the coronal convex surface of the implant adapter 4 and forms a cutting edge 5 in this place.

The coronal surface of the suprastructure 3, onto which the screw head 6 of the screw 2 is screwed, is implemented through a convex spherical surface of radius R3. The underside of the screw head 6 is a concave spherical surface of the same radius of curvature R3. As a result, the screw 2 and/or the underside of the screw head 6 can be tightened, surface-to-surface, on the upper side of the suprastructure 3. Accordingly, this results in a stable surface-to-surface connection of the screw 2, the suprastructure 3, and the stem 1 to the implant adapter 4 independent of the angle alpha (α) of the suprastructure 3 with respect to the implant adapter 4.

To be exact and according to the spirit of the entire present invention, the spherical surfaces are parts of a spherical surface. Accordingly, the afore-mentioned spherical surfaces are part-surfaces of spheres of radii R1, R2 or R3. For example the radius of curvature R1 of the coronal surface of the implant adapter 4 is 70 mm. For example the radius of curvature R2 of the apical surface of the suprastructure 3 is 60 mm. For example the radii of curvature R3 of the coronal surface of the suprastructure 3 and of the underside of the screw head 6 are 100 mm.

Upon the screw 2 being tightened, the cutting edge 5 of the suprastructure 3 cuts into the coronal surface of the implant adapter 4 and thus enables a firm and tight connection of said two components. In order to facilitate the cutting process, the suprastructure 3 is made of a harder material than the implant adapter 4. For example, the suprastructure 3 can consist of a titanium alloy (for example a hard “grade 5” titanium alloy) and the implant adapter 4 can consist of pure titanium or a softer titanium alloy (for example a softer “grade 2” titanium alloy).

Accordingly, the position of the cutting edge 5 is going to be established as a function of the angle between the suprastructure 3 and the implant adapter 4. Accordingly, the dental implant according to the invention shown here can be used to implement different angles between the suprastructure 3 and the implant adapter 4, and thus the stem 1, without having to use any adhesive or cement for this purpose.

The features of the invention disclosed in the preceding description and in the claims, figures, and exemplary embodiments, can be essential for the implementation of the various embodiments of the invention both alone and in any combination.

### LIST OF REFERENCE NUMBERS

1 Stem
2 Screw
3 Suprastructure
4 Implant adapter
5 Cutting edge
6 Screw head

1: Dental implant comprising an implant adapter (4) and a suprastructure (3), wherein
the implant adapter (4) is coronally arched in at least some sections and the suprastructure (3) is apically arched in at least some sections, the apical curvature of the suprastructure (3) being convex and the coronal curvature of the implant adapter (4) being concave or the apical curvature of the suprastructure (3) is concave and the coronal curvature of the implant adapter (4) is convex, and the concave curvature is more pronounced than the convex curvature such that, in the assembled dental implant, the suprastructure (3) is connected to said implant adapter (4) by a cutting edge (5).

2: Dental implant according to claim 1, wherein
the convex curvature is arched to be convex at a first radius R1 and the concave curvature is arched concave at a second radius R2, whereby the first radius R1 is larger than the second radius R2.

3: Dental implant according to claim 1, wherein
the convex curvature is a convex spherical surface having a first radius R1 and the concave curvature is a concave spherical surface having a second radius R2.

4: Dental implant according to claim 2, wherein the radii R1 and R2 are between 1 mm and 500 mm.

5: Dental implant according to claim 2, wherein the ratio of radii R1 to R2 is less than 2:1.

6: Dental implant according to claim 1, wherein
the curved surfaces comprise different diameters, such that, in the assembled dental implant, the external edge of the surface having the smaller diameter cuts as cutting edge (5) into the surface having the larger diameter.

7: Dental implant according to claim 1, wherein
the implant adapter (4) having the convex coronal surface is comprised of a softer material than the suprastructure (3) or the suprastructure (3) having the convex apical surface is comprised of a softer material than the implant adapter (4).

8: Dental implant according to claim 1, wherein
the implant adapter (4) and/or the suprastructure (3) are comprised of a cobalt-chromium alloy, titanium, a titanium alloy and/or a ceramic material.

9: Dental implant according to claim 1, wherein
the dental implant comprises a stem (1) for implanting into the jaw bone, whereby the implant adapter (4) can be placed on the stem (1) or can be connected to the stem (1) or is firmly connected to the stem (1) or is designed to be the same part as the stem (1).

10: Dental implant according to claim 1, wherein
the dental implant comprises a screw (2) for connecting the suprastructure (3) to the implant adapter (4), whereby the screw (2) comprises a thread for engaging an opposite thread, whereby the opposite thread optionally is arranged as internal thread in the stem (1), and the suprastructure (3) and the implant adapter comprises a feed-through (4) for the screw (2), whereby, optionally, at least the diameter of the feed-through in the suprastructure (3) is larger than the diameter of the screw (2) in the region of the thread and smaller than the diameter of a screw head (6) of the screw (2).

11: Dental implant according to claim 10, wherein
the suprastructure (3) comprises a convex coronal spherical surface having a radius R3 and the screw (2) possesses, on the underside of the screw head (6), a concave spherical surface having the same radius R3 such that a surface-to-surface contact of the underside of the screw head (6) to the coronal spherical surface of the suprastructure (3) is producible at different angles of the suprastructure (3) with respect to the implant adapter (4).

12: Dental implant according to claim 1, wherein
the assembly of the dental implant includes an angle between the implant adapter (4) and the suprastructure (3) and/or the stem (1) and the suprastructure (3) that is adjustable from 0° to 5°.
